(19) United States
(12) Patent Application Publication
(10) Pub. No.: US 2024/0028617 A1
(43) Pub. Date: Jan. 25, 2024

(54) RECORDING MEDIUM, LABELING ASSISTANCE DEVICE, AND LABELING ASSISTANCE METHOD

(71) Applicant: Mitsubishi Electric Corporation, Tokyo (JP)

(72) Inventor: Naoki SUGAWARA, Tokyo (JP)

(73) Assignee: Mitsubishi Electric Corporation, Tokyo (JP)

(21) Appl. No.: 18/037,567

(22) PCT Filed: Jun. 15, 2021
(86) PCT No.: PCT/JP2021/022730

§ 371 Date: May 18, 2023

(51) Int. Cl. G06F 16/28; G06N 20/00

(52) U.S. Cl. CPC G06F 16/285; G06N 20/00

(57) ABSTRACT

A labeling assistance device (10) includes an unlabeled data acquirer (11) and a labeling necessity determiner (13). The unlabeled data acquirer (11) acquires unlabeled data. The labeling necessity determiner (13) determines, based on labeled data, whether labeling of the unlabeled data is necessary.

### TECHNICAL FIELD

The present disclosure relates to a program, a labeling assistance device, and a labeling assistance method.

### BACKGROUND ART

In machine learning, a trained model may be generated from manually labeled data. For example, a trained model may be generated by supervised learning that uses a manually attached label as ground truth data. When such trained model generation involves preparation of a large amount of training data, the large amount of data is to be labeled manually. This can be a large burden. Thus, techniques are awaited for reducing the burden of labeling.

For example, Patent Literature 1 describes a technique related to the above. In labeling time-series data, when data acquired at one time is labeled, the technique reduces the burden of labeling data by automatically attaching the same label to data similar to the labeled data among unlabeled data items acquired near the time.

### CITATION LIST

### Patent Literature

Patent Literature 1: Unexamined Japanese Patent Application Publication No. 2016-76073

### SUMMARY OF INVENTION

### Technical Problem

However, the technique described in Patent Literature 1 automatically labels unlabeled data acquired near the time of the acquisition of labeled data alone, and may thus be insufficient to reduce the burden of labeling. For example, when the time of the acquisition of unlabeled data similar to labeled data differs greatly from the time of the acquisition of the labeled data, labeling of the unlabeled data is necessary separately.

An objective of the disclosure is to provide, for example, a program for appropriately reducing the burden of labeling unlabeled data.

### Solution to Problem

To achieve the above objective, a program according to an aspect of the present disclosure is a program for causing a computer to function as unlabeled data acquisition means for acquiring unlabeled data, and labeling necessity determination means for determining, based on labeled data, whether labeling of the unlabeled data is necessary.

### Advantageous Effects of Invention

The technique according to the above aspect of the present disclosure appropriately reduces the burden of labeling unlabeled data.

### BRIEF DESCRIPTION OF DRAWINGS

FIG. 1 is a schematic diagram of a data management system according to Embodiment 1 of the present disclosure;

FIG. 2 is a functional block diagram of a labeling assistance device according to Embodiment 1 of the present disclosure;

FIG. 3 is a diagram illustrating example labeling necessity determination performed by the labeling assistance device according to Embodiment 1 of the present disclosure;

FIG. 4 is a diagram illustrating example labeling necessity determination performed by the labeling assistance device according to Embodiment 1 of the present disclosure;

FIG. 5 is a diagram of the labeling assistance device according to Embodiment 1 of the present disclosure, illustrating an example hardware configuration;

FIG. 6 is a flowchart illustrating example labeling necessity determination performed by the labeling assistance device according to Embodiment 1 of the present disclosure;

FIG. 7 is a diagram illustrating example labeling necessity determination performed by a labeling assistance device according to Embodiment 2 of the present disclosure;

FIG. 8 is a flowchart illustrating example labeling necessity determination performed by the labeling assistance device according to Embodiment 2 of the present disclosure;

FIG. 9 is a functional block diagram of a labeling assistance device according to Embodiment 3 of the present disclosure;

FIG. 10 is a flowchart illustrating example labeling necessity determination performed by the labeling assistance device according to Embodiment 3 of the present disclosure; and

FIG. 11 is a functional block diagram of a labeling assistance device according to a modification of the present disclosure.

### DESCRIPTION OF EMBODIMENTS

Embodiments are described below with reference to the drawings. In each embodiment, a labeling assistance device according to one or more embodiments of the present disclosure is used in a data management system. In the figures, the same reference signs denote the same or equivalent components.

### Embodiment 1

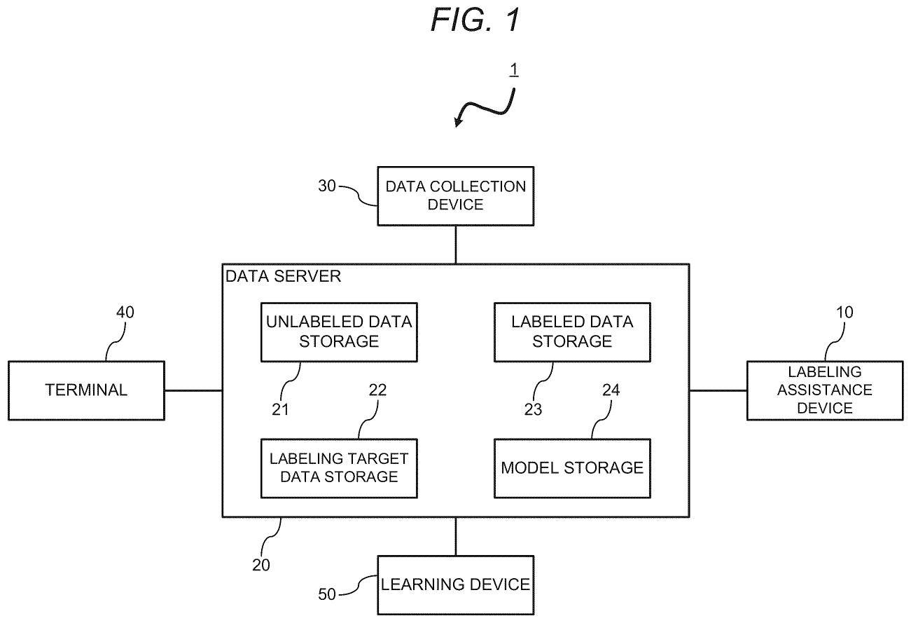

A data management system 1 according to Embodiment 1 is described with reference to FIG. 1. The data management system 1 includes a labeling assistance device 10, a data server 20, a data collection device 30, a terminal 40, and a learning device 50. The labeling assistance device 10, the data collection device 30, the terminal 40, and the learning device 50 communicate with the data server 20. The data management system 1 generates a trained model based on data labeled by the user of the terminal 40. As described in detail later, the data management system 1 allows the labeling assistance device 10 to determine whether labeling of unlabeled data collected by the data collection device 30 is necessary.

The data management system 1 is, for example, a data management system that operates in a factory and generates a trained model based on data collected in the factory. The data server 20, the labeling assistance device 10, the data collection device 30, the terminal 40, and the learning device 50 are connected to one another through a factory network to allow communication between them. The generated trained model is, for example, used in abnormality determination performed by an abnormality determination device (not illustrated).

The data server 20 is, for example, installed in the factory and connected to the factory network. The data server 20 stores data collected by the data collection device 30 into an unlabeled data storage 21 as unlabeled data. The data server 20 stores labeling target data into a labeling target data storage 22. The labeling target data is unlabeled data determined by the labeling assistance device 10 to be labeled. The data server 20 stores labeled data into a labeled data storage 23. The labeled data is labeling target data labeled by the user of the terminal 40. The data server 20 stores a trained model generated by the learning device 50 into a model storage 24. The trained model is generated by the learning device 50 based on the labeled data.

The data collection device 30 collects data used to generate a trained model. For example, the data collection device 30 collects data indicating sensor values from various sensors installed in the factory. The data collection device 30 stores the collected data into the data server 20 as unlabeled data.

Based on the labeled data stored in the data server 20, the labeling assistance device 10 determines whether the unlabeled data stored in the data server 20 is to be labeled. The labeling assistance device 10 stores unlabeled data determined to be labeled into the data server 20 as labeling target data. The functional configuration of the labeling assistance device 10 and the details of labeling necessity determination are described later. The labeling assistance device 10 is an example of a labeling assistance device according to one or more embodiments of the present disclosure.

The terminal 40 is a mobile terminal such as a smartphone, a tablet terminal, or a human-machine interface (HMI) operable by an operator in the factory. The operator who is the user of the terminal 40 may operate the terminal 40 to identify the labeling target data stored in the data server 20 and label the labeling target data. When the user performs an operation to identify the labeling target data, the terminal 40 acquires the labeling target data from the data server 20 and displays information indicating the labeling target data on the screen. When the user performs a labeling operation, the terminal 40 stores labeled data including the labeling target data and the attached label into the data server 20.

The learning device 50 generates a trained model based on the labeled data stored in the data server 20. For example, the learning device 50 generates a trained model by supervised learning that uses the attached label included in labeled data as ground truth data. The learning device 50 stores the generated trained model into the data server 20.

Labeled data is generated by adding a label to unlabeled data. Labeled data includes, as main data, the data other than the label (hereafter referred to as main data included in the labeled data). In an example, labeled data includes data representing “100 grams, 20° C.” and a label indicating “To Be Cooked” attached to the data. The labeled data includes the data “100 grams, 20° C.” as the main data. For example, the labeled data is data representing “100 grams, 20° C., label: To Be Cooked.”

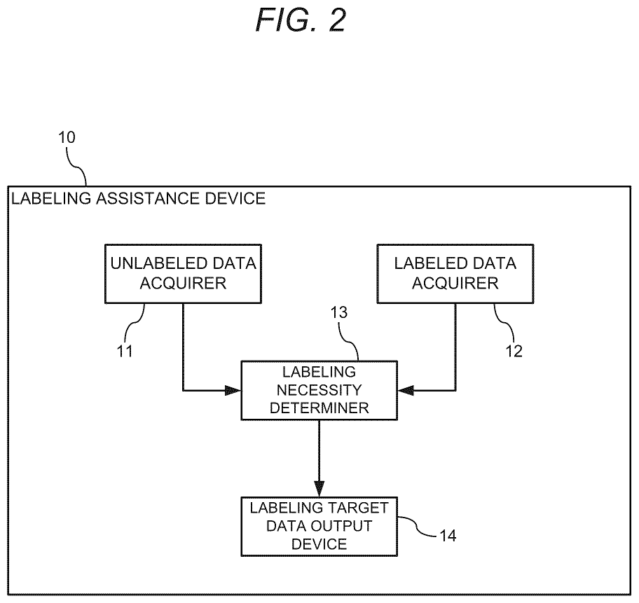

The functional configuration of the labeling assistance device 10 is now described with reference to FIG. 2. The labeling assistance device 10 includes an unlabeled data acquirer 11, a labeled data acquirer 12, a labeling necessity determiner 13, and a labeling target data output device 14.

The unlabeled data acquirer 11 acquires unlabeled data stored in the unlabeled data storage 21 in the data server 20. For example, the unlabeled data acquirer 11 communicates periodically with the data server 20 and acquires new unlabeled data upon addition of the unlabeled data to the unlabeled data storage 21. The unlabeled data acquirer 11 is an example of unlabeled data acquisition means in one or more embodiments of the present disclosure.

The labeled data acquirer 12 acquires labeled data stored in the labeled data storage 23 in the data server 20. However, the labeled data acquirer 12 need not acquire all the data items stored in the labeled data storage 23. For example, when acquiring all the data items increases the processing load, the labeled data acquirer 12 may acquire data to be used for labeling necessity determination (described later). For example, the labeled data acquirer 12 acquires data to be for labeling necessity determination by randomly acquiring 100 labeled data items stored in the labeled data storage 23 or acquiring the data labeled within a predetermined period. In particular, the criteria for labeling may change from day to day. The labeled data to be acquired may thus be limited to the data labeled within a predetermined period.

Based on the labeled data acquired by the labeled data acquirer 12, the labeling necessity determiner 13 determines whether labeling of the unlabeled data acquired by the unlabeled data acquirer 11 is necessary. The labeling necessity determiner 13 is an example of labeling necessity determination means in one or more embodiments of the present disclosure.

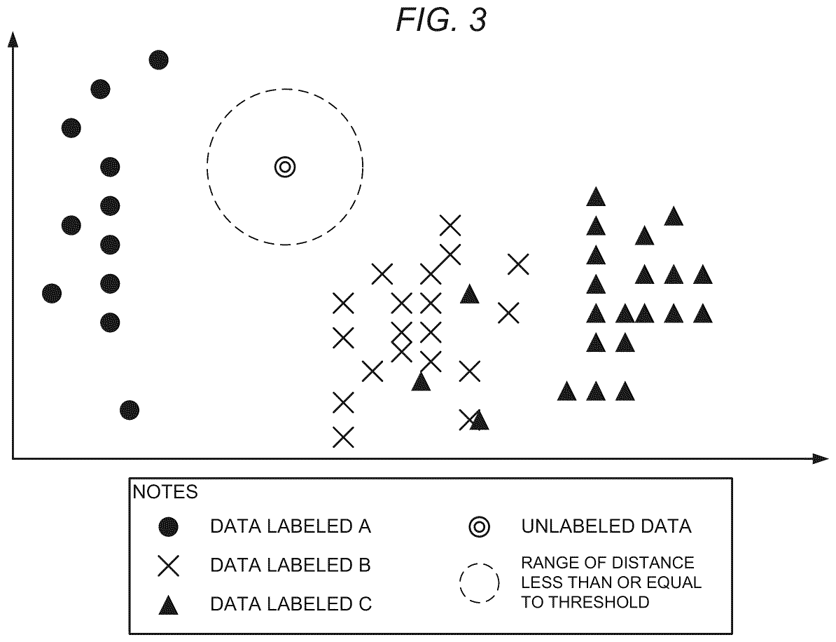

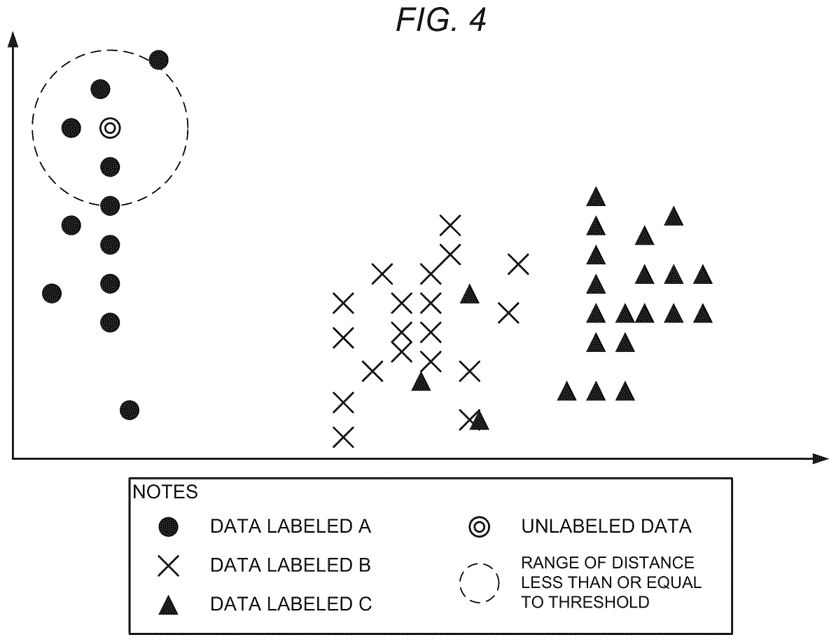

The labeling necessity determination is described in detail below with reference to FIGS. 3 and 4. FIGS. 3 and 4 each illustrate a labeled data distribution and unlabeled data. For ease of understanding, data in FIGS. 3 and 4 is a set of two values, or in other words, two-dimensional data. The labeled data distributions in FIGS. 3 and 4 are identical.

In FIGS. 3 and 4, the distance between the unlabeled data and each labeled data item can be calculated. The expression “the unlabeled data and each labeled data item” is more specifically “the distance between the unlabeled data and the main data included in the labeled data”. However, simply the expression “the unlabeled data and each labeled data item” is hereafter used for ease of explanation when no differentiation is intended.

For data that cannot be represented two-dimensionally unlike in FIGS. 3 and 4, the distance may be calculated in a certain manner. For data being a set of ten values each representing yes or no, the distance between data items can be determined by calculating the Hamming distance with yes as 1 and no as 0. For data being a set of mass and temperature, although the direct use of these numerical values is inappropriate for distance calculation, one of the values may be appropriately scaled to calculate an appropriate distance.

The labeling necessity determiner 13 calculates the distance between the unlabeled data and each labeled data item. With labeled data with a distance from the unlabeled data being less than or equal to a predetermined threshold, the labeling necessity determiner 13 determines that the unlabeled data is not to be labeled. Without labeled data with a distance from the unlabeled data being less than or equal to the threshold, the labeling necessity determiner 13 determines that labeling of the unlabeled data is necessary. In other words, the labeling necessity determiner 13 determines that the labeling is not to be performed with labeled data near the unlabeled data, whereas the labeling necessity determiner 13 determines that the labeling is to be performed with no labeled data near the unlabeled data.

In the example illustrated in FIG. 3, no labeled data has a distance from the unlabeled data being less than or equal to the threshold. Thus, in the example illustrated in FIG. 3, the labeling necessity determiner 13 determines that labeling of the unlabeled data is necessary. In contrast, in the example illustrated in FIG. 4, labeled data has a distance from the unlabeled data being less than or equal to the threshold. Thus, the labeling necessity determiner 13 determines that the unlabeled data is not to be labeled.

Referring back to FIG. 2, the labeling target data output device 14 outputs the unlabeled data determined to be labeled by the labeling necessity determiner 13 to the labeling target data storage 22 in the data server 20 as labeling target data.

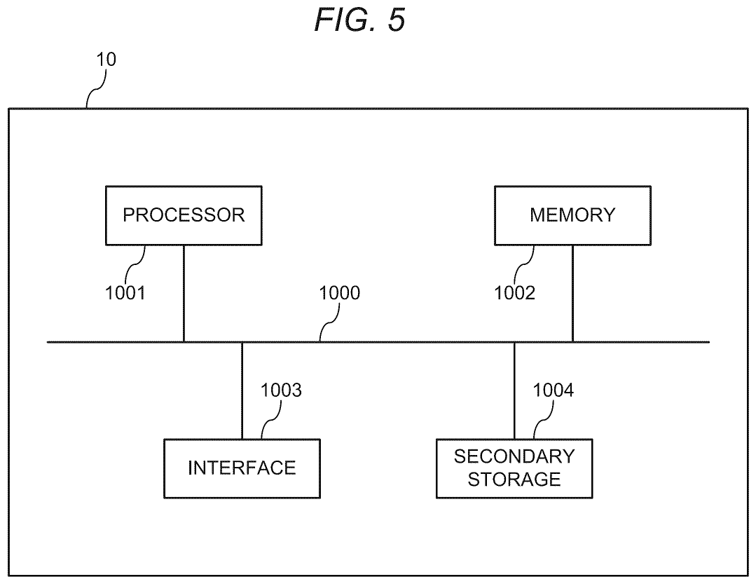

An example hardware configuration of the labeling assistance device 10 is now described with reference to FIG. 5. The labeling assistance device 10 illustrated in FIG. 5 is implemented by a computer such as a personal computer, an industrial personal computer, or a microcontroller.

The labeling assistance device 10 includes a processor 1001, a memory 1002, an interface 1003, and a secondary storage 1004 that are connected to one another with a bus 1000.

The processor 1001 is, for example, a central processing unit (CPU). When the processor 1001 loads an operation program stored in the secondary storage 1004 into the memory 1002 and executes the program, each function of the labeling assistance device 10 is implemented.

The memory 1002 is, for example, a main memory that is a random-access memory (RAM). The memory 1002 stores the operation program loaded by the processor 1001 from the secondary storage 1004. The memory 1002 also functions as a work memory when the processor 1001 executes the operation program.

The interface 1003 is, for example, an input-output (I/O) interface such as a serial port, a universal serial bus (USB) port, or a network interface.

The secondary storage 1004 is, for example, a flash memory, a hard disk drive (HDD), or a solid-state drive (SSD). The secondary storage 1004 stores the operation program executable by the processor 1001.

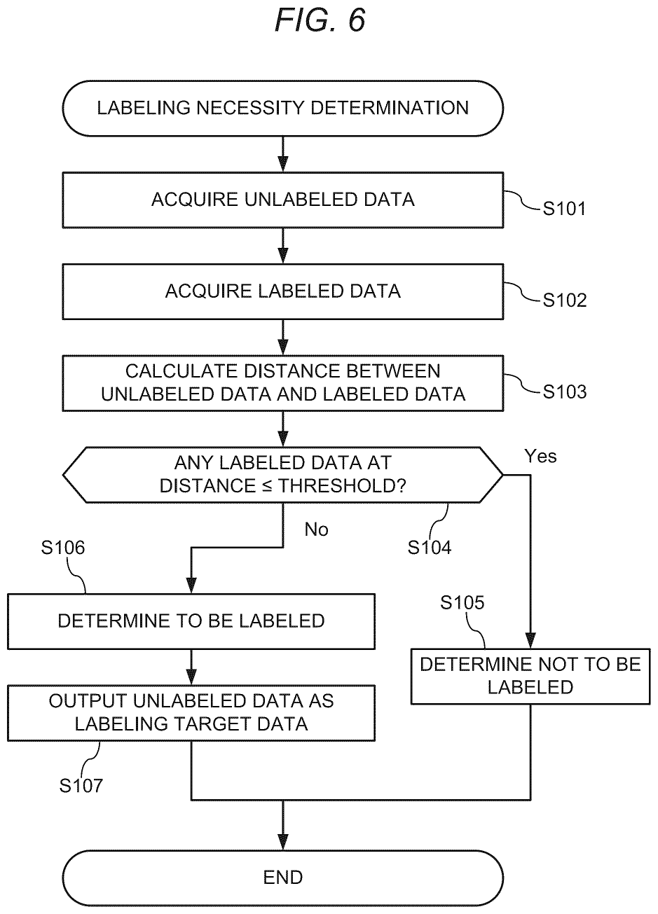

An example operation of the labeling necessity determination performed by the labeling assistance device 10 is now described with reference to FIG. 6. For example, the unlabeled data acquirer 11 in the labeling assistance device 10 checks the unlabeled data storage 21 in the data server 20 periodically, and the operation illustrated in FIG. 6 is started upon addition of new unlabeled data to the unlabeled data storage 21.

The unlabeled data acquirer 11 in the labeling assistance device 10 acquires unlabeled data stored in the unlabeled data storage 21 in the data server 20 (step S101).

The labeled data acquirer 12 in the labeling assistance device 10 acquires labeled data from the labeled data storage 23 in the data server 20 (step S102).

The labeling necessity determiner 13 in the labeling assistance device 10 calculates the distance between the unlabeled data acquired in step S101 and each labeled data item acquired in step S102 (step S103).

The labeling necessity determiner 13 determines whether the distance calculated in step S103 between the unlabeled data and any labeled data is less than or equal to the threshold (step S104).

With labeled data with a distance from the unlabeled data being less than or equal to the threshold (Yes in step S104), the labeling necessity determiner 13 determines that the unlabeled data is not to be labeled (step S105). The labeling assistance device then ends the operation of the labeling necessity determination.

Without labeled data with a distance from the unlabeled data being less than or equal to the threshold (No in step S104), the labeling necessity determiner 13 determines that labeling of the unlabeled data is necessary (step S106).

The labeling target data output device 14 in the labeling assistance device 10 outputs the unlabeled data to the labeling target data storage 22 in the data server 20 as labeling target data (step S107). The labeling assistance device 10 then ends the operation of the labeling necessity determination.

The data management system 1 according to Embodiment 1 has the configuration described above. Based on the distance between unlabeled data and labeled data, the labeling assistance device 10 in the data management system 1 determines whether labeling of the unlabeled data is necessary. Thus, the labeling assistance device 10 can appropriately reduce the burden of labeling unlabeled data.

### Embodiment 2

A data management system 1 according to Embodiment 2 is described below. The overall configuration of the data management system 1 and the functional configuration of a labeling assistance device 10 are substantially the same as in the example in Embodiment 1 illustrated in FIGS. 1 and 2, and differences from Embodiment 1 are described below.

In Embodiment 1, the labeling assistance device 10 determines whether labeling of unlabeled data is necessary based on the distance between the unlabeled data and labeled data. As described above, the distance between unlabeled data and labeled data is specifically the distance between the unlabeled data and the main data included in the labeled data, and the label attached to the unlabeled data is not used in the determination.

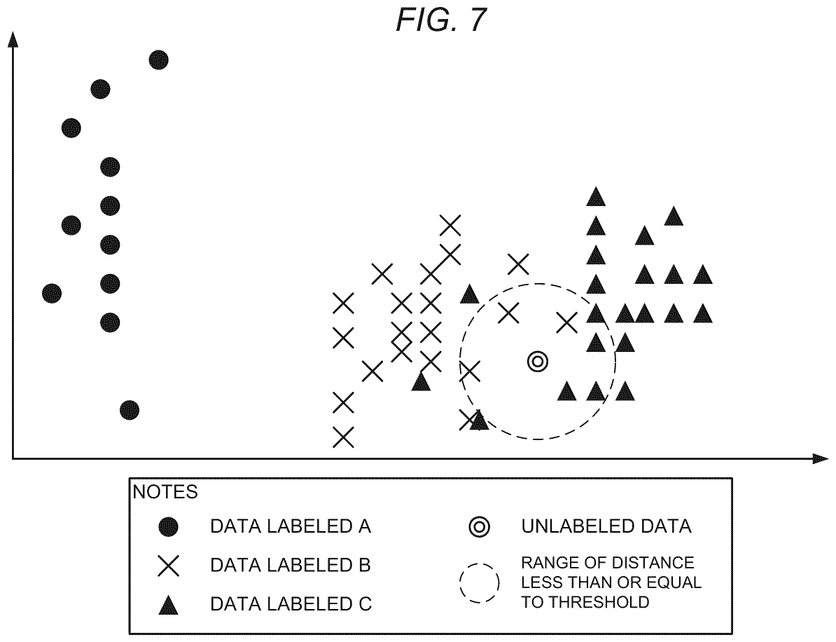

Thus, for example, data to be labeled in Embodiment 1 may be determined not to be labeled as described below. This example is described below with reference to FIG. 7.

FIG. 7 illustrates the same labeled data distribution as in FIGS. 3 and 4 but with different unlabeled data. As illustrated in FIG. 7, multiple items of data labeled B and data labeled C are within the range of the unlabeled data corresponding to a distance less than or equal to the threshold. For the unlabeled data, whether the data is to be labeled B or C is unknown and thus is to be determined to be labeled. However, the labeling assistance device 10 according to Embodiment 1 performs labeling necessity determination based on the distance between the unlabeled data and the main data included in the labeled data, and thus determines that the unlabeled data is not to be labeled.

To respond to this, the labeling assistance device 10 according to Embodiment 2 performs, as described below, the labeling necessity determination based on the main data included in the labeled data as well as on the attached label included in the labeled data.

With labeled data with a distance from the unlabeled data being less than or equal to the threshold, the labeling necessity determiner 13 in the labeling assistance device 10 according to Embodiment 2 determines that labeling of the unlabeled data is necessary when different labels are included in the labeled data at a distance less than or equal to the threshold. In the example illustrated in FIG. 7, the labeled data with a distance from the unlabeled data being less than or equal to the threshold includes two types of labels, or specifically, label B and label C. Thus, in Embodiment 2, the labeling necessity determiner 13 determines that the unlabeled data in the example illustrated in FIG. 7 is to be labeled.

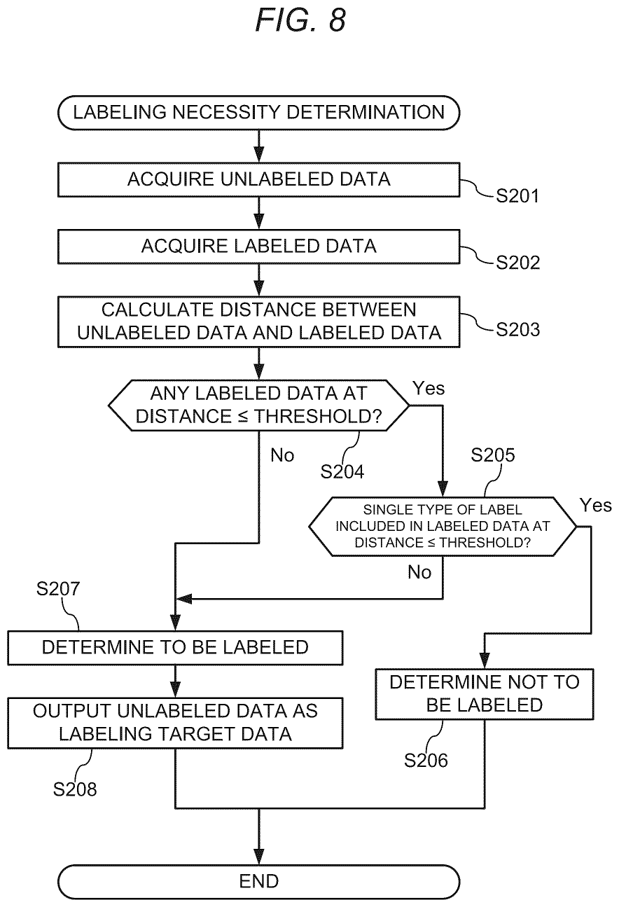

The operation of the labeling necessity determination performed by the labeling assistance device 10 according to Embodiment 2 is described with reference to FIG. 8, focusing on differences from the example in Embodiment 1 illustrated in FIG. 6.

The operation from steps S201 to step S204 is identical to steps S101 to S104 in FIG. 6 and is thus not described. Additionally, without labeled data being at a distance less than or equal to the threshold (No in step S204), the operation in and after step S207 is identical to the operation in and after step S106 in FIG. 6 and is thus not described.

With labeled data being at a distance less than or equal to the threshold (Yes in step 204), the labeling necessity determiner 13 determines whether a single type of label is included in the labeled data with a distance from the unlabeled data being less than or equal to the threshold (step S205).

With a single type of label included in the labeled data with a distance from the unlabeled data being less than or equal to the threshold (Yes in step S205), the labeling necessity determiner 13 determines that the unlabeled data is not to be labeled (step S206). The labeling assistance device 10 then ends the operation of the labeling necessity determination.

With multiple types of labels included in the labeled data with a distance from the unlabeled data being less than or equal to the threshold (No in step S205), the labeling necessity determiner 13 determines that labeling of the unlabeled data is necessary (step S207). A subsequent operation is identical to the operation in and after step S107 in FIG. 6 and is thus not described.

The data management system 1 according to Embodiment 2 has the configuration described above. The labeling assistance device 10 in the data management system 1 according to Embodiment 2 performs the labeling necessity determination based on the main data included in the labeled data as well as on the attached label included in the labeled data. Thus, the labeling assistance device 10 according to Embodiment 2 may reduce the burden of labeling unlabeled data more appropriately than the labeling assistance device 10 according to Embodiment 1.

### Embodiment 3

A data management system 1 according to Embodiment 3 is described below. The overall configuration of the data management system 1 is substantially the same as the example in Embodiment 1 illustrated in FIG. 1, and differences from Embodiment 1 are described below.

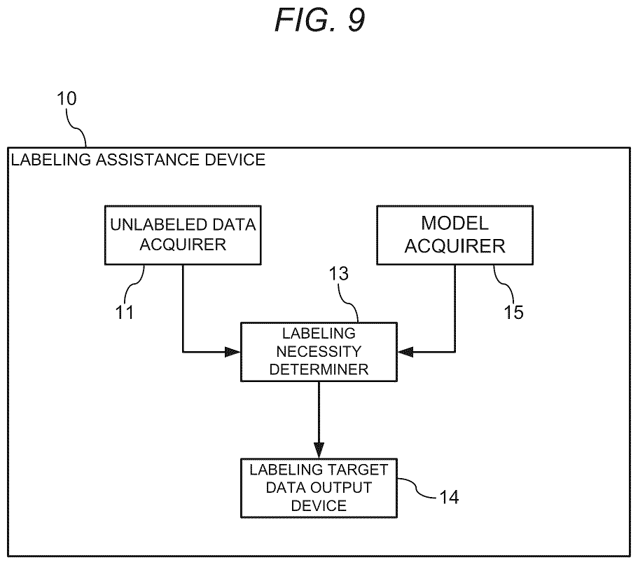

As also illustrated in FIG. 9, a labeling assistance device 10 according to Embodiment 3 differs from the structure in Embodiment 1 in including a model acquirer in place of the labeled data acquirer 12. The model acquirer 15 acquires the trained model from the model storage 24 in the data server 20.

As described below, the labeling necessity determiner 13 is also different from the corresponding component in Embodiment 1. Based on the trained model acquired by the model acquirer 15, the labeling necessity determiner 13 in Embodiment 3 determines whether labeling of unlabeled data is necessary. More specifically, the labeling necessity determiner 13 in Embodiment 3 uses the trained model to infer the label to be attached to the unlabeled data. When a likelihood acquired during the inference is greater than or equal to a predetermined threshold, the labeling necessity determiner 13 determines that the unlabeled data is not to be labeled. When the likelihood is less than the threshold, the labeling necessity determiner 13 determines that labeling of the unlabeled data is necessary. As described in detail later, the likelihood is an index indicating the degree of inference reliability.

As described above, the trained model is generated by the learning device 50 based on labeled data. Thus, the trained model may be used to infer the label to be attached to unlabeled data. For a trained model generated by, for example, machine learning that uses logistic regression, or machine learning based on deep learning that uses the softmax function as an activation function for the output layer, the likelihood of each label may be acquired as an inference. The likelihood can be a value of 0 to 1. The total of the likelihood values of the labels is 1. A likelihood value nearer 1 indicates a more reliable inference, whereas a likelihood value nearer 0 indicates a less reliable inference.

For example, when unlabeled data and labeled data used for model learning are the same as in FIG. 3, the label-A likelihood and the label-C likelihood are each expected to be about 0.5, and one likelihood value may not be far greater than the other. When unlabeled data and labeled data used for model learning are the same as in FIG. 4, the label-A likelihood is expected to be large and near 1, and the label-B likelihood and the label-C likelihood are expected to be small and near 0. When unlabeled data and labeled data used for model learning are the same as in FIG. 7, the label-B likelihood and the label-C likelihood are each expected to be about 0.5, and one likelihood value may not be far greater than the other. Thus, in an example with a threshold of 0.7, when unlabeled data and labeled data used for model learning are the same as in FIG. 3 or 7, the unlabeled data is determined to be labeled. When unlabeled data and labeled data used for model learning are the same as in FIG. 4, the unlabeled data is determined not to be labeled.

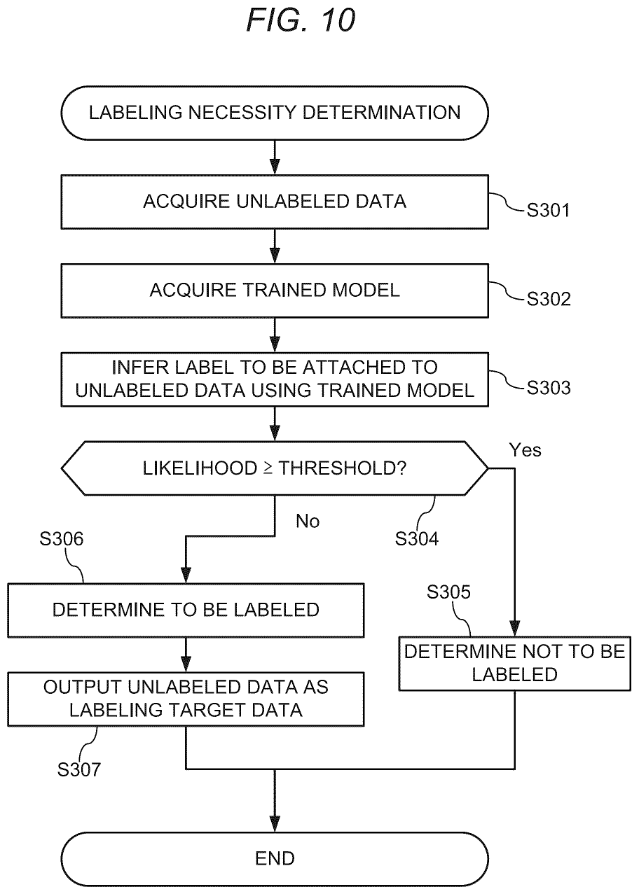

The operation of the labeling necessity determination performed by the labeling assistance device 10 according to Embodiment 3 is described below with reference to FIG. 10, focusing on differences from the example in Embodiment 1 illustrated in FIG. 6. The operation of steps S301, S305, S306, and S307 is identical to the operation of steps S101, S105, S106, and S107 in FIG. 6 and is thus not described.

The model acquirer 15 in the labeling assistance device 10 acquires the trained model from the model storage 24 in the data server 20 (step S302).

The labeling necessity determiner 13 in the labeling assistance device 10 infers, using the trained model acquired in step S302, the label to be attached to the unlabeled data acquired in step S301 (step S303).

The labeling necessity determiner 13 determines whether the likelihood acquired during the inference in step S303 is greater than or equal to the threshold (step S304).

When the likelihood is greater than or equal to the threshold (Yes in step S304), the labeling necessity determiner 13 determines that the unlabeled data is not to be labeled (step S305). The labeling assistance device 10 then ends the operation of the labeling necessity determination.

When the likelihood is less than the threshold (No in step S304), the labeling necessity determiner 13 determines that labeling of the unlabeled data is necessary (step S306). The operation in and after step S307 is identical to the operation in and after step S107 in FIG. 6 and is thus not described.

The data management system 1 according to Embodiment 3 has the configuration described above. The labeling assistance device 10 in the data management system 1 according to Embodiment 3 determines whether labeling of unlabeled data is necessary based on the trained model generated from labeled data. Thus, the labeling assistance device 10 according to Embodiment 3 can appropriately reduce the burden of labeling unlabeled data.

### MODIFICATIONS

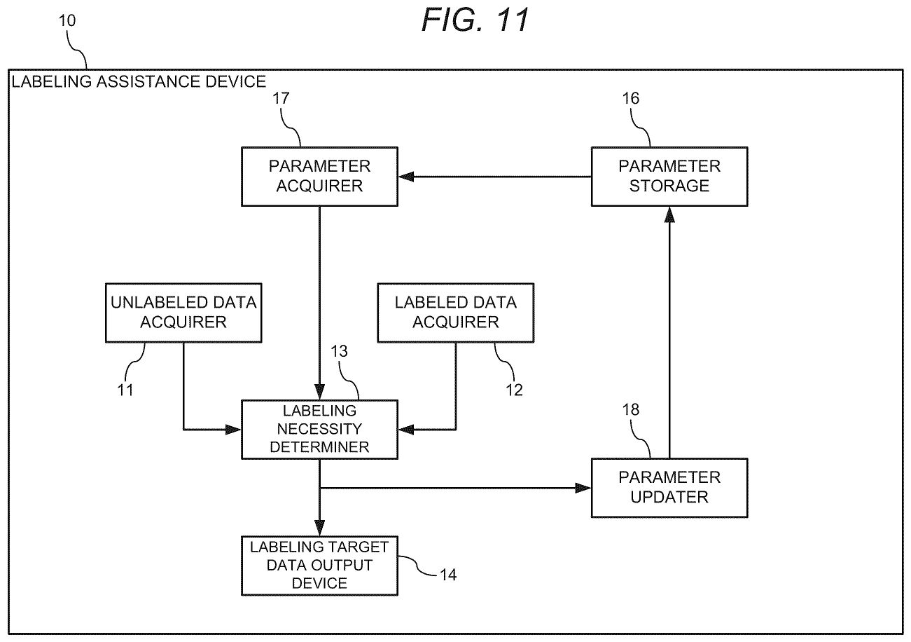

In Embodiments 1 and 2, the threshold used for the distance determination is predetermined. However, the threshold may be updated for each labeling necessity determination. As illustrated in FIG. 11, for example, the labeling assistance device 10 further includes a parameter storage 16, a parameter acquirer 17, and a parameter updater 18. The parameter storage 16 stores a threshold used for distance determination. The parameter acquirer 17 acquires the threshold stored in the parameter storage 16. The labeling necessity determiner 13 determines whether the distance is less than or equal to the threshold acquired by the parameter acquirer 17. The parameter updater 18 updates the threshold stored in the parameter storage 16 based on the result of the labeling necessity determination performed by the labeling necessity determiner 13. The parameter storage 16 is an example of storage means in one or more embodiments of the present disclosure. The parameter acquirer 17 is an example of parameter acquisition means in one or more embodiments of the present disclosure. The parameter updater 18 is an example of parameter update means in one or more embodiments of the present disclosure.

A threshold may not be determined initially for certain labeling target data for which an appropriate threshold is unclear. With a threshold being too small, data may be determined to be labeled although the labeling is not to be performed. With a threshold being too large, data may be determined not to be labeled although the labeling is to be performed. Thus, for example, a threshold may be appropriately adjusted by increasing the threshold for data determined to be labeled or reducing the threshold for data determined not to be labeled.

The threshold of likelihood in Embodiment 3 may also be modified similarly to the above modification. More specifically, the labeling assistance device 10 in Embodiment 3 may further include the parameter storage 16, the parameter acquirer 17, and the parameter updater 18. The parameter storage 16 may store the threshold used for likelihood determination.

In Embodiments 1 and 2, the labeling necessity determiner 13 performs the labeling necessity determination based on the distance between the unlabeled data and the labeled data. Instead, the labeling necessity determiner 13 may calculate the center of gravity of the overall labeled data and perform the labeling necessity determination based on the distance between the unlabeled data and the center of gravity. In Embodiment 2, the center of gravity may be calculated for each group of labeled data to which the same label is attached. The labeling necessity determination may be performed based on the distance between the unlabeled data and the center of gravity of each group.

In Embodiments 1 and 2, the labeling necessity determiner 13 calculates the distance for data. Instead, the labeling necessity determiner 13 may calculate the feature quantity of data and then calculate the distance for the feature quantity. For example, for 100-dimensional data, the labeling necessity determiner 13 may calculate the two-dimensional feature quantity based on the 100-dimensional data and then calculate the distance for the calculated two-dimensional feature quantity. The precalculation of the feature quantity reduces the computation in distance calculation.

In Embodiments 1 and 2, the labeling necessity determiner 13 performs the labeling necessity determination based on whether the distance between the unlabeled data and any labeled data is less than or equal to the threshold. Instead, the labeling necessity determination may be performed based on whether the number of labeled data items with a distance from the unlabeled data being less than or equal to the threshold is less than or equal to a predetermined number. For example, with a high threshold in Embodiments 1 and 2, a single labeled data item may cause determination that many unlabeled data items are not to be labeled, possibly generating extremely few labeled data items. This may be avoided by performing the labeling necessity determination based on whether the number of labeled data items with a distance from the unlabeled data being less than or equal to the threshold is less than or equal to the predetermined number.

In Embodiment 3, the labeling assistance device 10 performs the labeling necessity determination based on a single trained model. Instead, the labeling assistance device 10 may perform the labeling necessity determination based on multiple trained models. More specifically, the learning device 50 generates multiple trained models. The labeling assistance device 10 performs the labeling necessity determination based on inferences from the multiple trained models. The learning device 50 generates multiple trained models based on, for example, different algorithms for training or different parameters for training. The labeling necessity determiner 13 in the labeling assistance device 10 infers the label to be attached to the unlabeled data based on each trained model. In some examples, the labeling necessity determiner 13 determines that labeling is not to be performed simply when all the labels inferred based on the trained models match. In other examples, the labeling necessity determiner 13 may determine that labeling is not to be performed simply when at least a predetermined number of labels inferred based on the trained models match.

In each embodiment, the data server 20 and the learning device 50 are installed on the factory network. Instead, the data server 20 and the learning device 50 may be cloud servers on the Internet. In this example, the labeling assistance device 10, the data collection device 30, and the terminal 40 communicate with the data server 20 through the Internet. The data server 20 and the learning device 50 may be installed on the same cloud or set on separate clouds.

In each embodiment, the labeling assistance device 10, the terminal 40, and the learning device 50 are separate devices. Instead, one device may serve as some or all of the devices. For example, the labeling assistance device 10 may function as the terminal 40, the terminal 40 may function as the learning device 50, or the labeling assistance device 10 may function as the terminal 40 and as the learning device 50.

In the hardware configuration illustrated in FIG. 5, the labeling assistance device 10 includes the secondary storage 1004. However, the secondary storage 1004 may be external to the labeling assistance device 10, and the labeling assistance device 10 and the secondary storage 1004 may be connected to one another with the interface 1003. In this configuration, the secondary storage 1004 may be a removable medium such as a USB flash drive or a memory card.

In place of the hardware configuration illustrated in FIG. 5, the labeling assistance device 10 may have a dedicated circuit including an application-specific integrated circuit (ASIC) or a field-programmable gate array (FPGA). In the hardware configuration illustrated in FIG. 5, some functions of the labeling assistance device 10 may be implemented by, for example, a dedicated circuit connected to the interface 1003.

The program used in the labeling assistance device 10 may be distributed on a non-transitory computer-readable recording medium such as a compact disc read-only memory (CD-ROM), a digital versatile disc (DVD), a USB flash drive, a memory card, or an HDD. A specific or a general-purpose computer on which the program is installed can function as the labeling assistance device 10.

The program may be stored in a storage in another server on the Internet and may be downloaded from the server.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1 Data management system
10 Labeling assistance device
11 Unlabeled data acquirer
12 Labeled data acquirer
13 Labeling necessity determiner
14 Labeling target data output device
15 Model acquirer
16 Parameter storage
17 Parameter acquirer
18 Parameter updater
20 Data server
21 Unlabeled data storage
22 Labeling target data storage
23 Labeled data storage
24 Model storage
30 Data collection device
40 Terminal
50 Learning device
1000 Bus
1001 Processor
1002 Memory
1003 Interface
1004 Secondary storage

1. A non-transitory computer-readable recording medium storing a program, the program causing a computer to function as
an unlabeled data acquirer to acquire unlabeled data, and
a labeling necessity determiner to determine, based on main data of labeled data and a label included in the labeled data, whether labeling of the unlabeled data is necessary, wherein
the labeling necessity determiner determines, without main data of labeled data with a distance from the unlabeled data being less than or equal to a threshold, that labeling of the unlabeled data is necessary.

2. The non-transitory computer-readable recording medium according to claim 1, wherein
the labeling necessity determiner
determines, with different labels included in the labeled data with the distance from the unlabeled data being less than or equal to the threshold, that labeling of the unlabeled data is necessary, and
determines, with a single type of label included in the labeled data with the distance from the unlabeled data being less than or equal to the threshold, that the unlabeled data is not to be labeled.

3. The non-transitory computer-readable recording medium according to claim 1, wherein
the program further causes the computer to function as
a parameter acquirer to acquire the threshold stored in a storage, and
a parameter updater to update the threshold stored in the storage, wherein
the labeling necessity determiner determines, based on the threshold acquired by the parameter acquirer, whether labeling of the unlabeled data is necessary, and
the parameter updater updates the threshold based on a determination result provided by the labeling necessity determiner.

4. The non-transitory computer-readable recording medium according to claim 3, wherein
the labeling necessity determiner determines, based on a trained model generated from the labeled data, whether labeling of the unlabeled data is necessary.

5. The non-transitory computer-readable recording medium according to claim 1, wherein
the labeling necessity determiner determines, based on a labeled data item included in the labeled data and labeled within a predetermined period, whether labeling of the unlabeled data is necessary.

6. (canceled)

7. A labeling assistance device, comprising:
circuitry to
acquire unlabeled data;
determine, based on main data of labeled data and a label included in the labeled data, whether labeling of the unlabeled data is necessary; and
determine, without main data of labeled data with a distance from the unlabeled data being less than or equal to a threshold, that labeling of the unlabeled data is necessary.

8. A labeling assistance method, comprising:
acquiring, by a computer, unlabeled data;
determining, by the computer, based on main data of labeled data and a label included in the labeled data, whether labeling of the unlabeled data is necessary; and
determining, by the computer, without main data of labeled data with a distance from the unlabeled data being less than or equal to a threshold, that labeling of the unlabeled data is necessary.
